(19) United States
(12) Patent Application Publication
(10) Pub. No.: US 2025/0019162 A1
(43) Pub. Date: Jan. 16, 2025

(54) A STORAGE MODULE FOR AN AUTOMATED STORAGE AND RETRIEVAL SYSTEM AND METHOD FOR USING SAME

(71) Applicant: Autostore Technology AS, Nedre Vats (NO)

(72) Inventor: Jørgen Djuve Heggebø, Langhus (NO)

(73) Assignee: Autostore Technology AS, Nedre Vats (NO)

(21) Appl. No.: 18/714,462

(22) PCT Filed: Nov. 23, 2022
(86) PCT No.: PCT/EP2022/082981

§ 371 Date: May 29, 2024

(30) Foreign Application Priority Data
Nov. 30, 2021 (NO) 20211441

(51) Int. Cl. B65G 1/02; B65G 1/04; B65G 1/06

(52) U.S. Cl. CPC B65G 1/026; B65G 1/0464; B65G 1/065

(57) ABSTRACT

A storage module is for supporting goods holders in an automated storage and retrieval system. The storage module includes a vertically extending structure, and a support segment pivotably supported by the vertically extending structure with a vertical axis of rotation. The support segment includes a supporting part for supporting a goods holder.

### FIELD OF THE INVENTION

The present invention relates to an automated storage and retrieval system for storage and retrieval of goods holders, in particular to a storage module for storing and presenting goods holders to a user.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

The digging process enables a high utilization of the available storage space in a storage and retrieval system. However, the digging process require more time for retrieving a target goods holder as compared to directly accessing the target goods holders.

It is an objective of the present invention to provide a storage module wherein goods holders can be arranged in a column and be individually stored and retrieved without the need for digging.

### SUMMARY OF THE INVENTION

The present invention is set forth and characterized in the independent claims, while the dependent claims describe other characteristics of the invention.

The present invention relates to a storage module for supporting goods holders in an automated storage and retrieval system, wherein the storage module comprises:
a vertically extending structure, and
a plurality of support segments being pivotably supported by the vertically extending structure with a mutual vertical axis of rotation and distributed with vertical offsets such that the plurality of support segments are arranged one above another,
wherein each support segment comprises:
a supporting part for supporting a goods holder, and
a guiding part for guiding vertical movement of a goods holder, wherein the supporting part and the guiding part of each support segment are arranged on opposite sides of the axis of rotation.

An advantage of the storage module is that a plurality of support segments can be accessed via a common column. A target goods holder which is supported by a support segment of the storage module, at any level within the storage module, can be accessed easily through at most a rotation of the support segments that are positioned above the support segment supporting the target goods holder so that the guiding parts are in alignment. Thus, several points of access for a user may be provided, these being in vertical alignment with one another, and with the storage module taking up a limited horizontal area.

The user may e.g. be a warehouse worker, a robotic picker, or a customer picking up an order. The order may comprise groceries or other goods which were purchased online.

A non-target support segment may be selectively rotated to provide access to a target support segment arranged below or to receive a goods holder through the same common column of the storage module.

The supporting part may be used to store goods holders within the storage module. The goods holder may be stored for a short or long period of time, depending on the storage situation.

The supporting part may be used to present a target goods holder to a picker or user of the storage module.

The guiding part may be configured to at least partly encircle a goods holder being guided. The goods holder being guided might be a goods holder which is intended to be supported on, or a goods holder which has been supported on, a lower support segment of the storage module.

The goods holder may e.g. be a storage container, a bin, a tote, a pallet, a tray or similar. Different types of goods holders may be used in the same system. The goods holders may have different heights.

The vertical offsets may correspond to different floors or levels of a building or a cube storage. The different floors or levels may not be adjacently arranged, i.e. other floors or levels may be arranged in between.

The vertical offsets may correspond to at least the height of the support segment such that the support segments are arranged on top of each other.

The vertical offsets may be equal vertical offsets, unequal vertical offsets, or a combination thereof.

The storage module may comprise actuators for powering the individual movement of the support segments, typically one actuator per support segment. Each support segment may thus be rotated without interacting with any one of the other support segments which thus may be kept stationary, rotated at different speeds, rotated in the opposite direction, and/or rotated to other orientations.

The storage module may comprise a controller configured for controlling rotational movement of the support segments. The controller may also control other components of the storage module or other parts of an automated storage and retrieval system in which the storage module is arranged.

The guiding part and the supporting part may counterbalance each other (at least to an extent, e.g., 50% or more). The guiding part may be provided with additional weights, e.g., made heavier than the supporting part, to at least in part counterbalance a weight of a goods holder being supported by the supporting part.

The guiding part and the supporting part may comprise similar or matching forms that are arranged back-to-back on opposite sides of the vertical axis of rotation.

The storage module may be retrofitted to an automated storage and retrieval system as disclosed herein.

The storage module may comprise only one support segment.

In one aspect, a transfer column is formed when guiding parts of support segments arranged above a target supporting part are vertically aligned with each other, and wherein the supporting part of each support segment is also alignable with the formed transfer column.

Each support segment may thus provide a section of a transfer column below a retrieval/drop-off position of the storage module.

The vertically aligned guiding parts may be configured to provide continuous guiding surfaces, e.g. by being sized corresponding to the sizing of the framework structure. In the formed transfer column, upright members may not be required for guiding purposes.

Alternatively, the guiding parts may be configured to provide a continuation of guiding surfaces of upright members of the frame structure, e.g., between a pair of support segments, to form a transfer column together with the guiding surfaces. The upright members may be arranged above, below or in between the guiding parts.

The guiding parts may be able to align with an above transfer column by rotating the support segment 180 degrees.

In one aspect, the goods holders that the guiding parts are intended to guide are rectangular in outline and the guiding part extends at least partly along four sides of such a goods holder to be guided.

The guiding part may thus stabilize the motion of the goods holder as it is being lowered/raised within the storage module.

The guiding part may extend all the way around the perimeter of the goods holder to be guided, e.g. along 4 sides to form a rectangle. Alternatively, the guiding part may extend along 3 sides and two small portions of the fourth side.

In one aspect, the vertically extending structure forms a part of the transfer column.

The vertically extending structure may be configured for guiding vertical movement of a goods holder. Thus, greater vertical offsets between the support segments may be allowed.

In one aspect, the vertically extending structure comprises at least one vertical pole or a plurality of horizontal supporting rings.

The support segments may be arranged on the pole in such a manner that the pole defines their axis of rotation.

Alternatively, the storage module may comprise ring bearings arranged between the support segments. A higher support segment may be supported on a lower support segment by a ring bearing. The load from the segment above can be carried by the ring bearing to the support segment below. The ring bearing thus defining the axis of rotation of the support segments. In a storage module having a plurality of ring bearings, the ring bearings are preferably arranged coaxially, such that all the support segments have a common axis of rotation.

Alternatively, the support segments may be arranged on individual supporting rings in such a manner that the supporting rings define their axis of rotation. The supporting rings are preferably coaxially arranged with vertical offsets. The supporting rings may be formed as part of a protective housing or in other ways be arranged at the periphery of the storage module. The protective housing may form a cylinder around the storage module.

In one aspect, the supporting part and the guiding parts are arranged with their geometrical centers at equal distances from the axis of rotation.

In one aspect, the supporting part and the guiding part are configured to store and guide goods holders of the same size.

The supporting part and the guiding part may both have a rectangular geometry.

In one aspect, each guiding part comprises a plurality of vertical guiding surfaces.

The vertical guiding surfaces of the guiding part may align with upright members to provide a continuation of the guiding surfaces for the goods holder. The corners of the guiding parts may be spaced by the same distance as the upright members. The vertically guiding surfaces of the guiding part may have a length corresponding to the separation of the upright members.

In one aspect, the storage module comprises a blocker configured to restrict horizontal access between the supporting part and the guiding part being arranged on opposite sides of the axis of rotation.

The vertical blocking element may preferably be configured to prevent a user from getting injured through accessing the oppositely arranged guiding part when accessing the supporting part.

In one aspect, the storage module comprises a plurality of access cabinets, each access cabinet being arranged adjacent a support segment and configured to provide selective access to a goods holder supported by the support segment.

The access cabinet may preferably be configured to provide access to the support segment when a goods holder stored on the supporting part is presented in the access cabinet. The storage module may thus provide one or more access stations, e.g., on different levels of a building.

The access cabinet may preferably be configured to prevent access to the support segment when the support segment is rotating around the vertical axis of rotation or when no goods holder is presented in the access cabinet.

The access cabinet may comprise a hatch or other form of barrier to prevent access when the supporting part of the support segment has not rotated into an access position within the access cabinet.

The access cabinet may be a delivery locker.

The storage module may further comprise a goods holder lift e.g. as disclosed in WO2014075937 as a bin lift.

In one aspect, each support segment comprises one or more flaps arranged on the supporting part and/or the guiding part, and wherein the one or more flaps are movable between:
a supporting position in which they are configured to store a goods holder, and
a stowed position in which they are configured to allow vertical passage of a goods holder.

In the supporting position, the flaps may provide an area that projects into an area defined by the supporting part through which vertical movement of a goods holder is prevented. A goods holder may be allowed to pass vertically through the same area when the supporting part is in the stowed position. In the stowed position, the flap may serve as a guide surface.

Each support segment may typically comprise two flaps.

In one aspect, the guiding part and the supporting part have the same geometry.

The support part and the guiding part may be C-shaped frames.

In one aspect, each support segment comprises:
a pair of supporting parts, and
a pair of guiding parts,
wherein the supporting parts and the guiding parts of each support segment are arranged on opposite sides of the axis of rotation.

If the support segment has a 2×2 arrangement, i.e. a pair of supporting parts and a pair of guiding parts, the axis of rotation may be arranged in the common corner region of the 4 parts.

If the support segment has a 1×2 arrangement, i.e. one supporting part and one guiding part, the axis of rotation may be arranged in the midpoint of the adjacent sides of the 2 parts.

The present invention also relates to an automated storage and retrieval system for storage and retrieval of goods holders, wherein the automated storage and retrieval system comprises:
a storage module as described herein,
a plurality of goods holders stored in the storage module,
a container handling vehicle comprising a lifting device configured to grab and vertically lift a goods holder from a supporting part rotated into alignment with a retrieval/drop-off position for the storage module, and
a control system configured to monitor and control wirelessly movements of the container handling vehicle.

The container handling vehicle may be a mobile crane or a goods holder lift, and the automated storage and retrieval system may comprise a delivery vehicle e.g. as disclosed in WO2019/238645A1 to receive a goods holder from the container handling vehicle.

The automated storage and retrieval system may further comprise a goods holder lift e.g. as disclosed in WO2014/075937 as a bin lift.

The automated storage and retrieval system may comprise a plurality of storage modules.

The storage module may preferably be arranged at the periphery of a storage grid of the automated storage and retrieval system, for example, an external periphery of a storage grid, but the storage module could also be positioned within an internal region of the of the storage grid.

In one aspect, the system comprises:
a rail system on which a plurality of container handling vehicles may be operated.

The rail system may be arranged above and/or below the storage module(s).

The rail system may comprise a first set of parallel rails arranged in a horizontal plane and extending in a first direction and a second set of parallel rails arranged in the horizontal plane and extending in a second direction which is orthogonal to the first direction, which first and second sets of rails form a grid pattern in the horizontal plane comprising a plurality of adjacent grid cells, each comprising a grid opening defined by a pair of neighbouring rails of the first set of rails and a pair of neighbouring rails of the second set of rails which a goods holder can be passed through.

The rail system may be arranged such that the supporting part(s) and guiding part(s) of each storage unit is vertically alignable with a grid opening.

The container handling vehicle may be operated along the rail system in at least one of the first direction X and the second direction Y.

In one aspect, the system comprises:
a plurality of vertical storage columns for stacking goods holders one on top of one another.

The present system is advantageous e.g. when the cold zone of the cold storage is limited to the grid, i.e. the rail system and the container handling vehicles are located outside the cold zone. By not having to perform digging operations, the period of heat exchange with the outside of the cold zone is reduced. Furthermore, only the target goods holder is retrieved to the outside of the cold zone.

This system will thus be particularly suited for storing groceries.

The present invention also relates to a method for retrieving a goods holder from an automated storage and retrieval system as described herein, wherein the method comprises the steps of:
moving the container handling vehicle to a position where its lifting device is positioned in vertical alignment above a retrieval/drop-off position for the storage module,
rotating a target support segment on which the target goods holder is stored to a first position where the supporting part is vertically aligned with the lifting device of the container handling vehicle,
if the target support segment is not the uppermost support segment, rotating the support segments arranged above the target support segment to a second position where their guiding parts are vertically aligned with the supporting part of the target support segment such that a transfer column is formed above the target goods holder,
grabbing and lifting the target goods holder by use of the lifting device, and
moving the container handling vehicle with the target goods holder to a horizontally different location.

The present invention also relates to a method for storing a goods holder in an automated storage and retrieval system as described herein, the method comprises the steps of:
moving the container handling vehicle carrying a goods holder to a position where its lifting device is positioned in vertical alignment above a retrieval/drop-off position for the storage module,
rotating a target support segment on which the target goods holder is to be stored to a first position where the supporting part is vertically aligned with the lifting device of the container handling vehicle,
if the target support segment is not the uppermost support segment, rotating the support segments arranged above the target support segment to a second position where their guiding parts are vertically aligned with the supporting part of the target support segment such that a transfer column is formed above the target goods holder, and
placing the goods holder on the target supporting part by use of the lifting device.

In one aspect, each support segment comprises one or more flaps arranged on the supporting part and being movable between:
a supporting position in which they are configured to support a goods holder, and
a stowed position in which they are configured to allow vertical passage of a goods holder,
wherein the method comprises the steps of:
moving the one or more flaps of the target supporting part to the supporting position, before placing the goods holder on the target supporting part.

In one aspect, the method further comprises the step of:
rotating the target support segment to the second position to be vertically aligned with the above support segments.

The supporting parts may thus form a storage column.

In one aspect, the storage module comprises a plurality of access cabinets, each access cabinet being arranged adjacent a support segment and configured to selectively provide access to the support segment,
wherein the method further comprises the steps of:
granting a user access to a target access cabinet.

In one aspect, each support segment comprises one or more flaps arranged on the guiding part and being movable between:
a supporting position in which they are configured to support a goods holder, and
a stowed position in which they are configured to allow vertical passage of a goods holder,
wherein the method further comprises the steps of:
moving the one or more flaps to the supporting position,
moving a second container handling vehicle carrying a second goods holder to a position where its lifting device is positioned in vertical alignment above the retrieval/drop-off position for the storage module,
placing the second goods holder on the one or more flaps of the target guiding part by use of the lifting device.

The storage module may be configured for movement within the automated storage and retrieval system. The storage module may also be configured for transportation to a different location outside the automated storage and retrieval system.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view of a prior art container handling vehicle having a storage space comprising a cavity arranged internally with the vehicle body;

FIG. 5 is a perspective view of an automated storage and retrieval system, wherein the automated storage and retrieval system comprises a plurality of vertical storage columns for stacking goods holders one on top of one another and a storage module;

FIG. 6 is a perspective view of a storage module comprising a plurality of support segments distributed at different layers and each support segment comprising a guiding part and a supporting part, wherein a container handling vehicle is about to store a goods holder on a target support segment arranged at a third uppermost layer;

FIG. 7 is a perspective view of the storage module of FIG. 6 wherein the container handling vehicle has stored a goods holder on a supporting part of the target support segment by means for lowering it through guiding parts of support segments arranged above the target support segment;

FIG. 8 is a perspective view of the storage module of FIG. 6 wherein the target support segment is rotating while supporting a goods holder;

FIG. 9 is a perspective view of the storage module of FIG. 6 wherein the target support segment is arranged with its guiding part in vertical alignment with above and below arranged guiding parts such that a transfer column is formed, and wherein the target support segment is arranged with its supporting part in vertical alignment with above and below arranged supporting parts such that a storage column is formed;

FIG. 10 is a perspective detailed view of the storage module of FIG. 6 showing a guiding part of the uppermost support segment;

FIG. 11a is a perspective view of a storage module comprising a plurality of support segments each comprising a guiding part and a supporting part, wherein the support segments are distributed on different floors;

FIG. 11b is a different perspective view of the storage module of FIG. 11a;

FIG. 12a is a front view of the storage module of FIG. 11a, wherein access cabinets are arranged adjacent the support segments;

FIG. 12b is a side view of the storage module of FIG. 11a, wherein the support segments receive and deliver goods holders to a delivery vehicle via a goods holder lift;

FIG. 13a is a perspective view of a detail of the storage module of FIG. 11a, showing in particular a support segment having a guiding part and a supporting part with the same geometry;

FIG. 13b is a detailed view of FIG. 13a, showing a flap arranged on the supporting part;

FIG. 14a is a different perspective view of the storage module of FIG. 13a, wherein the support segment is supporting a goods holder;

FIG. 14b is a perspective view of the storage module of FIG. 13a, wherein the support segment is supporting a goods holder;

FIG. 15a is a different perspective view of the storage module of FIG. 13a, wherein the support segment is rotating; and

FIG. 15b is a perspective view of the storage module of FIG. 13a, wherein the support segment is rotating.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings. For example, in the drawings, the goods holder is shown by way of storage containers. However, it is clear that other types of goods holders than storage can be used, such as bin, a tote, a pallet, a tray or similar.

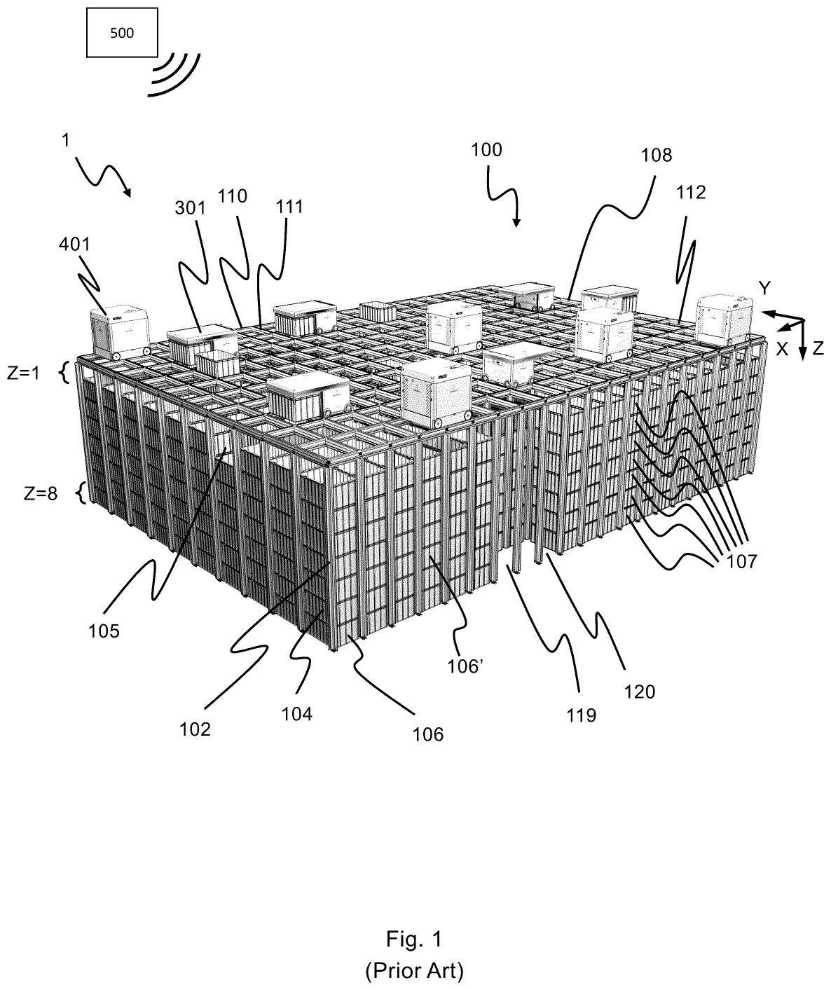

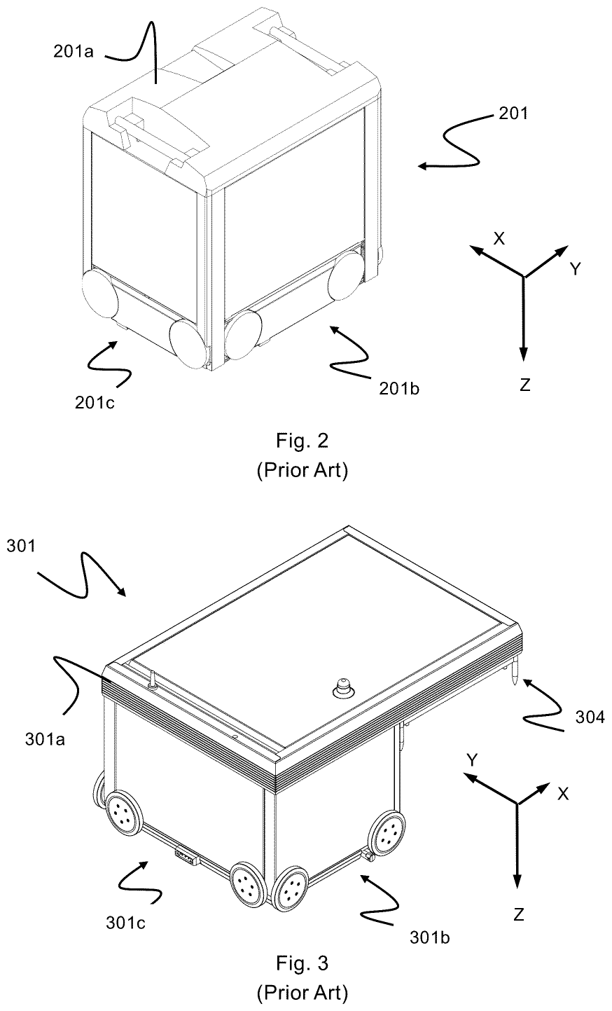

The framework structure 100 of the automated storage and retrieval system 1 is constructed in accordance with the prior art framework structure 100 described above in connection with FIGS. 1-3, i.e. a number of upright members 102, and further that the framework structure 100 comprises a first, upper rail system 108 in the X direction and Y direction.

The framework structure 100 further comprises storage compartments in the form of storage columns 105 provided between the members 102, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

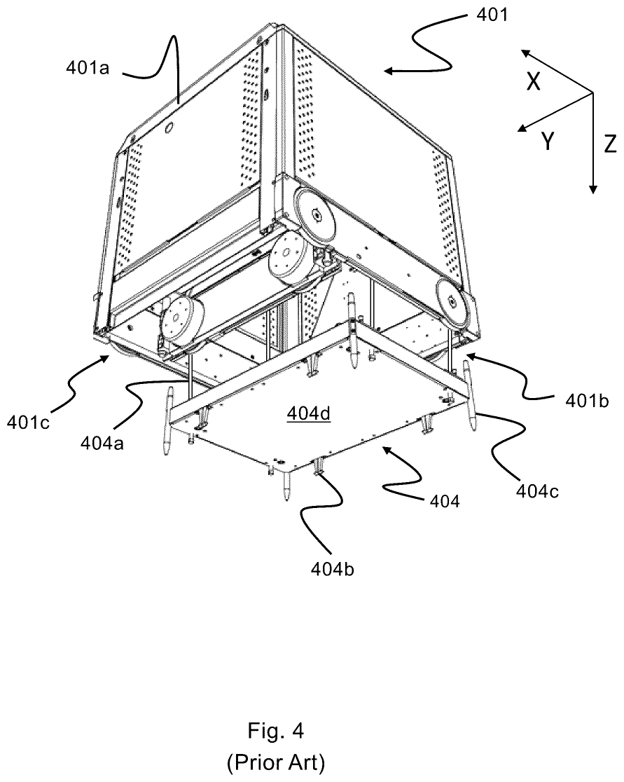

FIG. 4 shows a prior art container handling vehicle having a storage space comprising a cavity arranged internally with the vehicle body 401a.

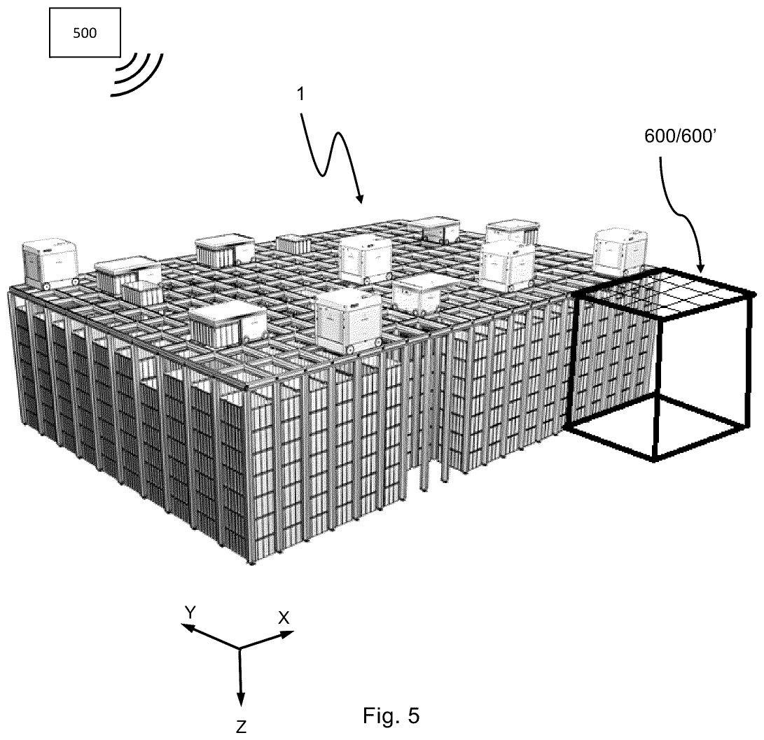

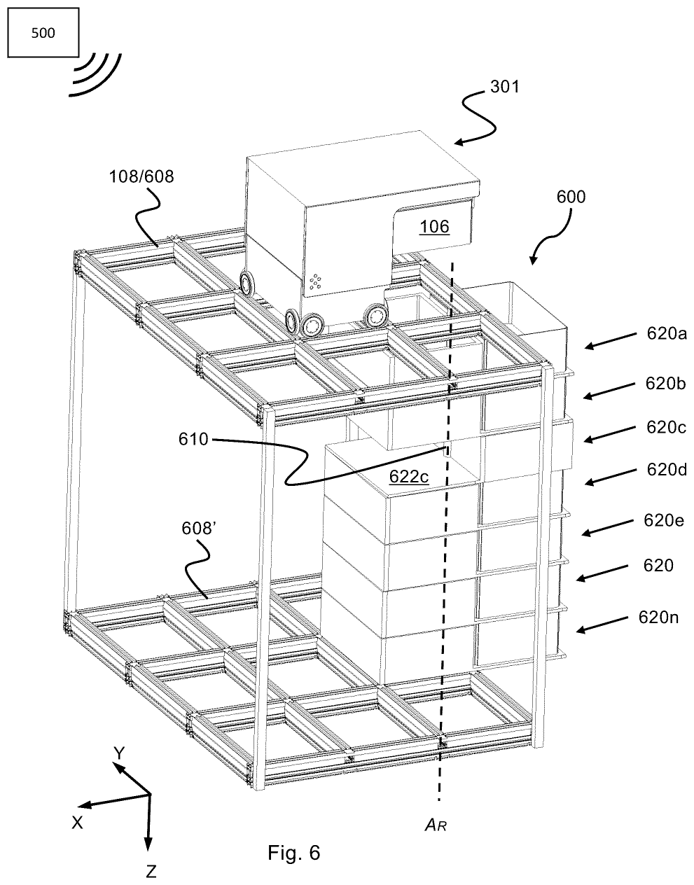

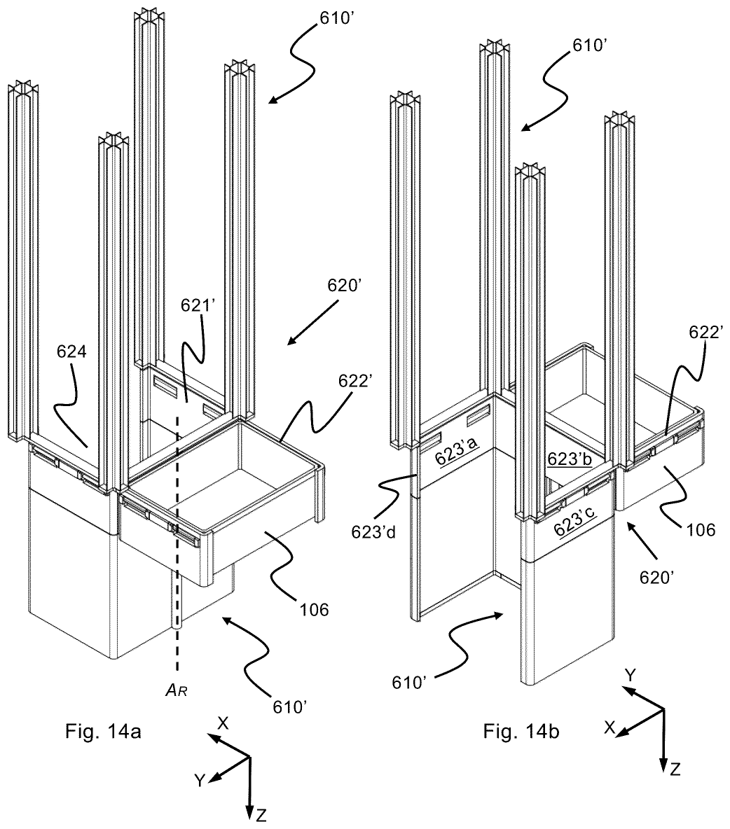

FIG. 5 shows an example of an automated storage and retrieval system according to the invention. The automated storage and retrieval system comprises a storage module 600; 600′. The storage module 600; 600′ may e.g. be a storage module 600; 600′ as illustrated in FIGS. 6-15b.

As illustrated in FIG. 5, the automated storage and retrieval system may comprise a plurality of vertical storage columns for stacking goods holders one on top of one another, e.g. as known from prior art automated storage and retrieval systems 1.

The automated storage and retrieval system will typically comprise a plurality of goods holders that can be stored at least temporarily in the storage module 600; 600′.

The automated storage and retrieval system will typically also comprise at least one container handling vehicle 201; 301; 401 comprising a lifting device configured to grab and vertically lift a goods holder from any one of the support segments 620 of the storage module 600. The automated storage and retrieval system will typically also comprise a rail system 108; 608; 608′ on which the at least one container handling vehicle 201; 301; 401 may be operated. The rail system 108; 608; 608′ may extend beyond the storage module 600; 600′ and cover at least a part of an adjacent storage section or connect with an adjacent rail system 108; 608; 608′.

A control system 500 may wirelessly monitor and control movements of the container handling vehicles 201; 301; 401.

In an automated storage and retrieval system comprising both a first storage section with a plurality of vertical storage columns for stacking goods holders one on top of one another and a second storage section with a storage module 600; 600′, the rail system 108; 608; 608′ preferably allows the at least one container handling vehicle 201; 301; 401 to move between the two sections.

FIG. 6 shows an automated storage and retrieval system comprising: a storage module 600 for supporting goods holders in an automated storage and retrieval system. The storage module 600 comprises a vertically extending structure 610, in the form of a rod, and a plurality of support segments 620a-n being pivotably supported by the vertically extending structure 610 with a mutual vertical axis of rotation A_{R} and distributed with vertical offsets ΔdVa-n such that the plurality of support segments 620 are arranged one above another.

Each support segment 620 may comprise a supporting part 622 for supporting a goods holder and a guiding part 621 for guiding vertical movement of a goods holder. The supporting part 622 and the guiding part 621 of each support segment 620 may be arranged on opposite sides of the axis of rotation A_{R}.

The automated storage and retrieval system illustrated in FIG. 6 may also comprise a plurality of goods holders stored in the storage module 600, a container handling vehicle 301 comprising a lifting device configured to grab and vertically lift a goods holder from a supporting part 622 rotated into alignment with a retrieval/drop-off position for the storage module 600, and a control system 500 configured to monitor and control wirelessly movements of the container handling vehicle 301.

The automated storage and retrieval system illustrated in FIG. 6 may comprise a rail system 108/608 arranged above the storage module 600 and/or a rail system 108′ arranged below the storage module 600. The container handling vehicle 301 may operate on the rail system 108/608 arranged above the storage module 600. Another container handling vehicle typically of a different type or a delivery vehicle 700 may operate on the rail system 108′ arranged below the storage module 600.

In FIG. 6, the container handling vehicle 301 is carrying a goods holder in the form of a storage container 106. The container handling vehicle 301 has been moved to a position where its lifting device is positioned in vertical alignment above the retrieval/drop-off position for the storage module 600. A support segment 620a in a first and uppermost layer and a support segment 620b in a second layer are rotated to position their guiding parts 621a,621b in vertical aligned with the lifting device of the container handling vehicle 301. A support segment 620c in a third layer has been rotated to position its supporting part 622c in vertical aligned with the lifting device of the container handling vehicle 301. The supporting part 622c of the support segment 620c in the third layer is ready to receive the goods holder carried by the container handling vehicle 301 and may be considered a target supporting part 622.

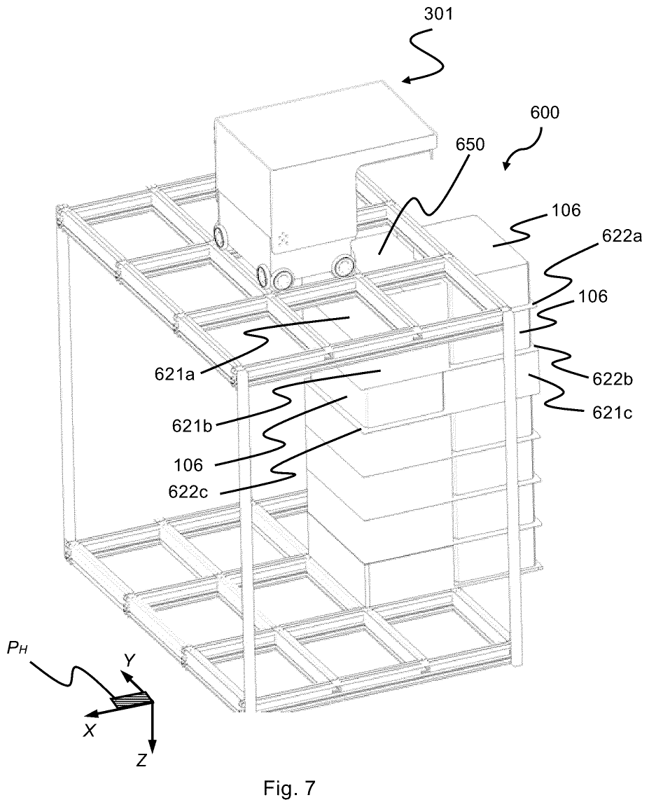

In FIG. 7 the container handling vehicle has placed the goods holder on the target supporting part 622c by use of its lifting device. The guiding part 621a in the first layer and the guiding part 621b in the second layer forms a transfer column 650 through which the goods holder can move when being placed on the target supporting part 622c.

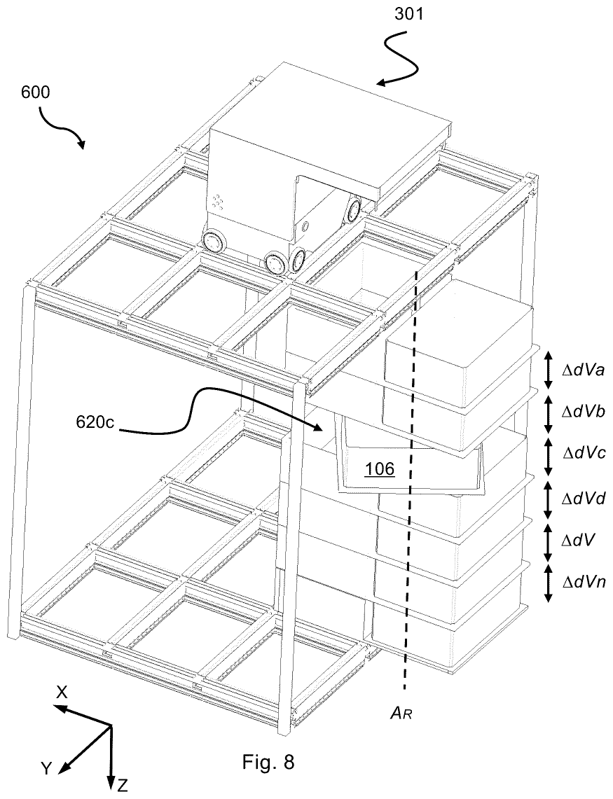

FIG. 8 shows the target support segment 620c being rotated around the axis of rotation A_{R}. A goods holder is being supported on the target support segment 620c.

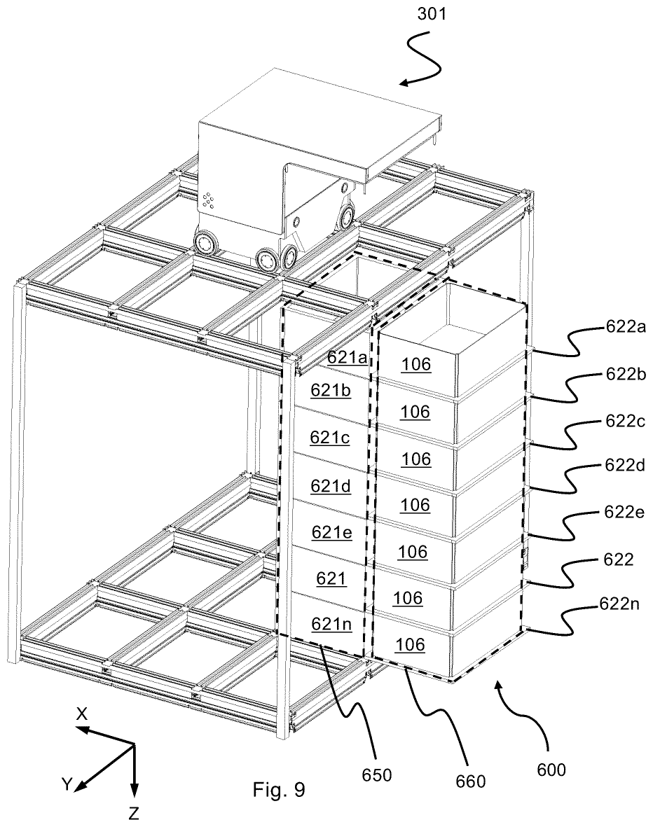

FIG. 9 shows how all supporting parts 622a-n can be vertically aligned to form a storage column 660 and all guiding parts 621a-n can be vertically aligned to form a transfer column 650. Each supporting part 622a-n are preferably vertically alignable with the transfer column 650, typically by means of rotation. In the example of FIG. 9, all the supporting parts 622a-n are supporting a goods holder each.

When the container handling vehicle 301 is to retrieve a target goods holder from the storage module 600, the above described process is reversed. From the configuration illustrated in FIG. 9, a target goods holder stored in the storage module 600 can be made available to the container handling vehicle 301 by means of rotating the target support segment 620. The target support segment 620 can be rotated to position its target supporting part 622, on which the target goods holder is supported, below the retrieval/drop-off position for the storage module 600. The guiding parts 621 arranged in vertical alignment above the target supporting part 622 forms a transfer column 650 through which the container handling vehicle 301 can retrieve the target goods holder by means of its lifting device. If a transfer column 650 has not been formed below the retrieval/drop-off position for the storage module 600, this can be done by rotating all the support segments 620 arranged above the target supporting segment 620 such that their guiding parts 621 are vertically aligned with the retrieval/drop-off position for the storage module 600.

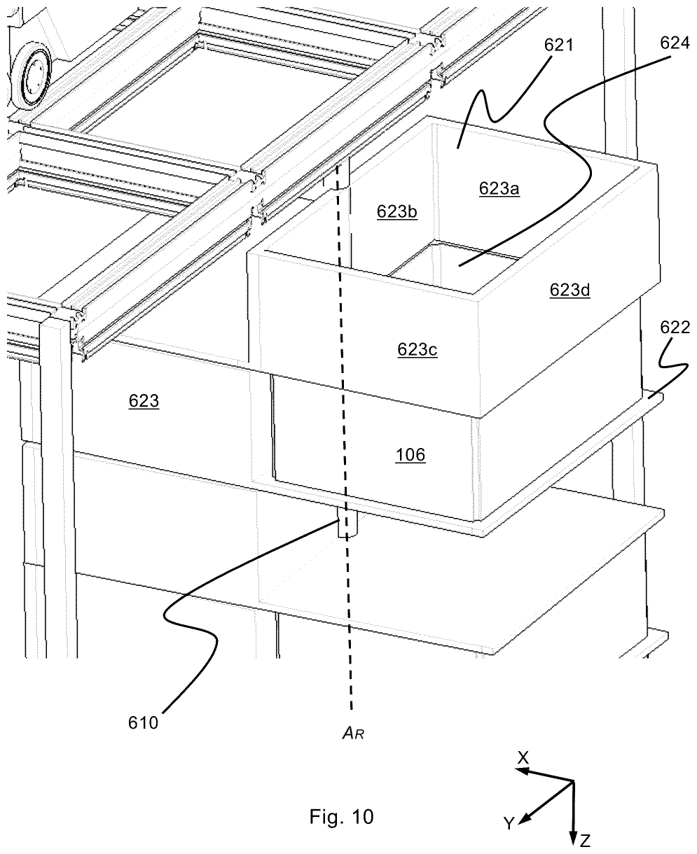

FIG. 10 shows a guiding part 621 vertically aligned above a supporting part 622. On the supporting part 622 a goods holder in the form of a storage container 106 is supported. The storage container 106 has a rectangular outline. The guiding part 621 has a hole 624 defined by four vertical guiding surfaces 623a-d. The vertical guiding surfaces 623a-d are configured to guide the storage container 106 and extends along all four sides of such a storage container 106 when it is guided through the hole 624.

FIG. 10 illustrates that the supporting part 622 and the guiding part 621 may preferably be configured to respectively store and guide goods holders of the same size.

By arranging the supporting part 622 and the guiding part 621 of each support segment 620 with their geometrical centers at equal distances from the axis of rotation A_{R}, the supporting parts 622 and the guiding parts 621 of two support segments 620 can selectively be vertically aligned with each other. As seen in FIG. 10, the support segment 620a in the first layer has a supporting part 622a and a guiding part 621a arranged with their geometrical centers at equal distances from the axis of rotation A_{R}, therefore they can both be vertically aligned with the supporting part 622b and the guiding part 621b of the support segment 620b in the second layer.

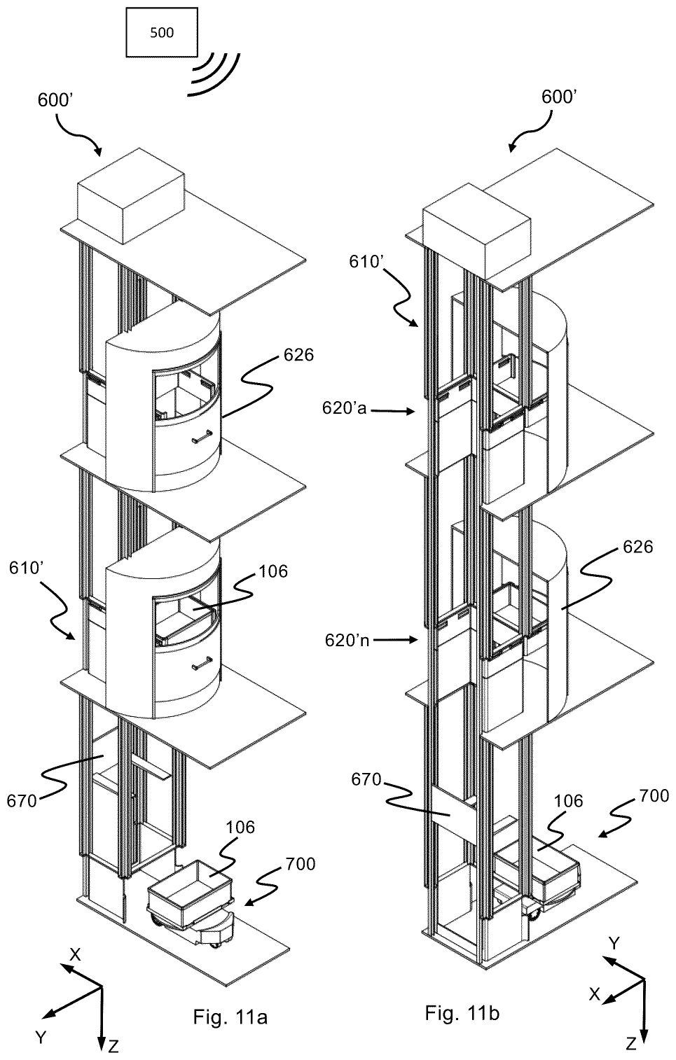

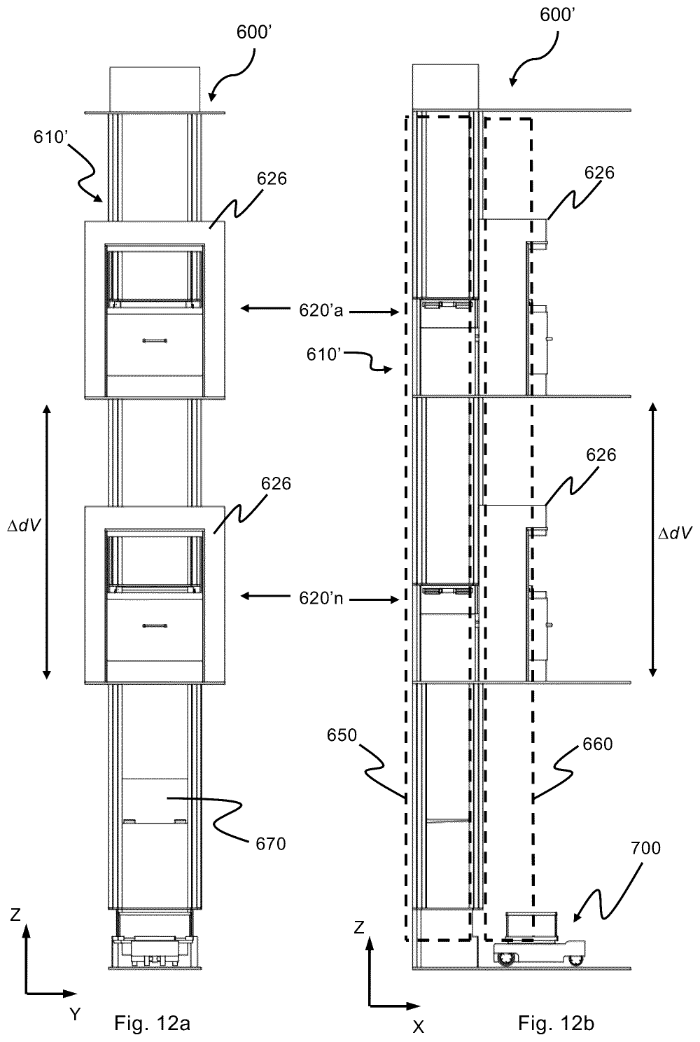

FIG. 11a and FIG. 11b show two perspective views, whereas FIG. 12a shows a front view and FIG. 12b shows a side view of the same automated storage and retrieval system. The automated storage and retrieval system of FIGS. 11a-12b has the same characteristics as the automated storage and retrieval system of FIGS. 6-10.

In FIGS. 11a-12b, the vertically extending structure 610′ comprises four upright members (as illustrated above the guiding part 621′). The vertically extending structure 610′ may also or alternatively comprise one or more open housing(s) (as illustrated below the guiding part 621′). The vertically extending structure 610′ in the form of upright members and/or open housing(s) may form a part of the transfer column 650, typically in combination with at least one guiding part 621′. If the vertically extending structure 610′ forms a part of the transfer column 650 in combination with a plurality of guiding parts′, the vertically extending structure 610′ may be arranged between the guiding parts 621′. The vertically extending structure 610′ may comprise a plurality of discontinuous sections.

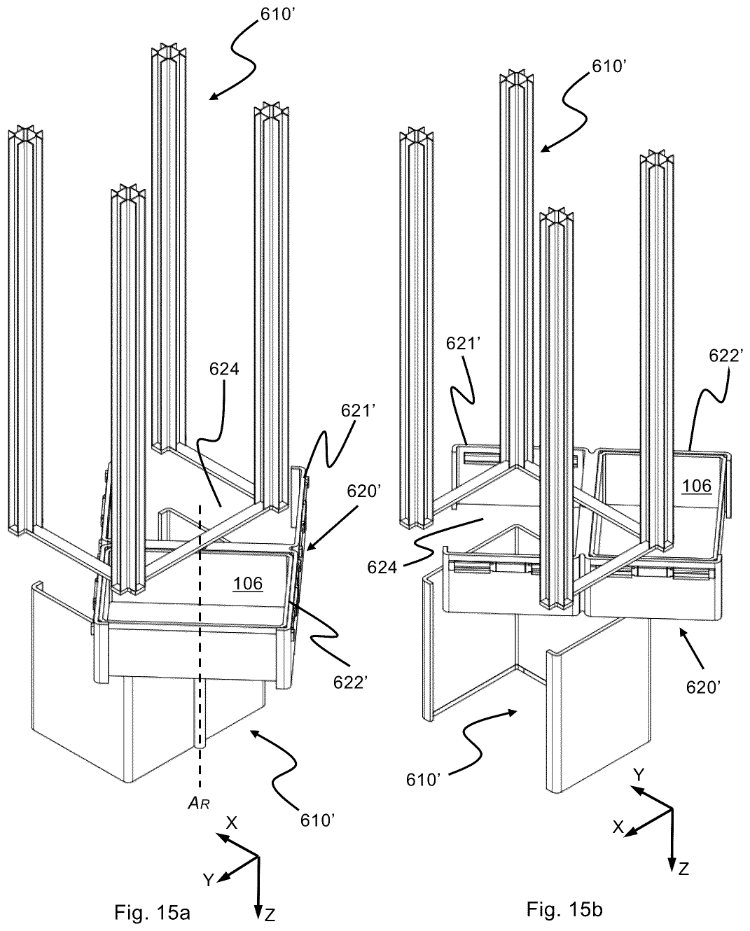

The vertically extending structure 610′ may also comprise a pole on which the support segment 620′ can be pivotably arranged, e.g. as illustrated in FIG. 15a.

The storage module 600′ exemplified in FIGS. 11a-12b has support segments 620′ that are arranged with vertical offsets ΔdV such that the support segments 620′ can be arranged on different floors of a building.

The storage module 600′ may comprise a plurality of access cabinets 626, each access cabinet 626 being arranged adjacent a support segment 620′ and configured to provide selective access to a goods holder supported by the support segment 620′. The access cabinet 626 has a sliding cover/hatch and may serve as a delivery locker where customers can collect their orders.

The access cabinet 626 may be arranged on the outside of a building and be configured to shield the support segment 620′ from the weather and other outdoor conditions.

The access cabinets 626 may be wirelessly monitored and operated by a control system 500, e.g. the same control system 500 that monitors and controls the support segments 620′ and/or the at least one container handling vehicle 301.

The goods holders can be stored and retrieved by means of a goods holder lift 670. The goods holder lift 670 may move vertically through the transfer column 650 to transfer goods holders from a delivery vehicle 700 or a container handling vehicle 201; 301; 401 to a support segment 620′ or vice versa.

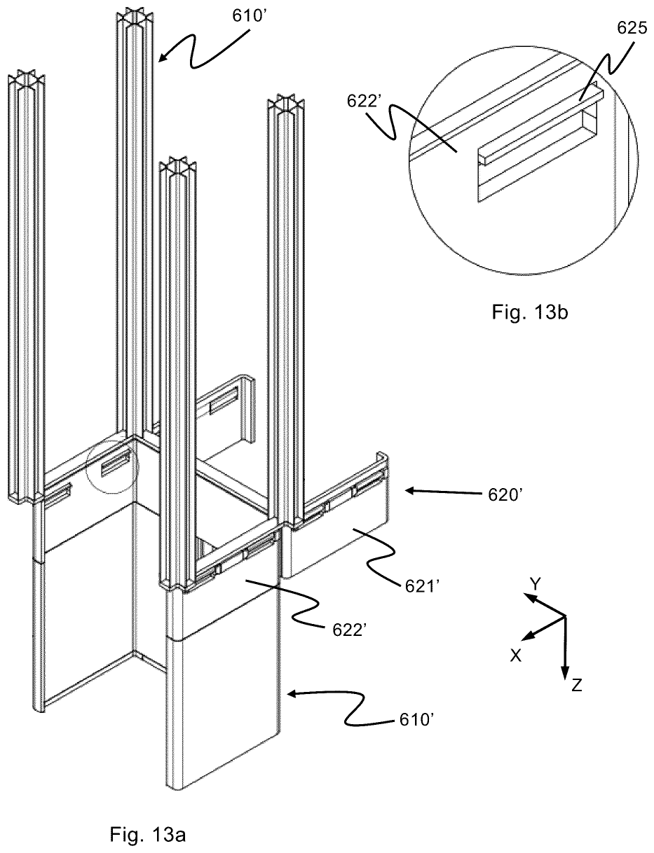

FIGS. 13a-15b show different perspective views of a part of the storage module 600′ of the automated storage and retrieval system of FIGS. 11a-12b.

FIG. 13b shows a detail of the support segment 620′ of FIG. 13a. As illustrated, the support segment 620′ may comprise one or more flaps 625 arranged on the supporting part 622′ and/or the guiding part 621′. The one or more flaps 625 may be movable between a supporting position in which they are configured to store a goods holder, and a stowed position in which they are configured to allow vertical passage of a goods holder. In the example of FIG. 13a, four flaps 625 are arranged on the support segment 620′ and four flaps 625 are arranged on the guiding part 621′.

The flap 625 in FIG. 13b is in the supporting position wherein the flap protrudes from the vertical guiding surface 623′ of the supporting part 622′. In the stowed position the flap 625 does not protrude from the vertical guiding surface 623′ and may e.g. be flush with the vertical guiding surface 623′ or retracted therein.

The flap 625 may be moved between the supporting position and the stowed position by means of horizontal or vertical pivoting. An electric motor may provide the pivoting movement of the flap 625. Alternatively, a stroking movement between the supporting position and the stowed position could be envisaged, typically caused by an electric actuator.

FIG. 13a shows that the guiding part 621′ and the supporting part 622′ may have the same geometry. By also comprising flaps 625, the supporting part 622′ may be used as a guiding part 621′ if the flaps 625 are moved to the stowed position, and the guiding part 621′ may be used as a supporting part 622′ if the flaps 625 are moved to the supporting position. If the guiding part 621′ is used as a supporting part 621′, the support segment 620′ may store two goods holders simultaneously.

The flaps 625 arranged on a supporting part 622′ may be moved to the stowed position to allow a goods holder lift 670 carrying a goods holder to be stored pass through, e.g. if the goods holder lift 670 is transferring a goods holder from below the support segment 620′. If said supporting part 622′ is a target supporting part 622′, its flaps 625 may be moved to the supporting position once the goods holder lift 670 carrying a goods holder to be stored has reached a position above the target supporting part 622′.

The guiding part 621′ may have a hole 624 defined by four vertical guiding surfaces 623′a-d. The vertical guiding surfaces 623′a-d are configured to guide the storage container 106 and extends at least partly along all four sides of such a storage container 106 when it is guided through the hole 624.

In the preceding description, various aspects of the automated storage and retrieval system according and methods to the invention have been described with reference to the illustrative embodiment. For example, as indicated above, in the Figures a storage container has been shown as an illustration of a goods holder but the invention extends to goods holders in other forms or known by other names, such as a bin, a tote, a pallet, a tray or similar may be used instead.

For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention as defined in the attached claims.

### LIST OF REFERENCE NUMBERS

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
600, 600′ Storage module
608, 608′ Rail system
610, 610′ Structure
620, 620a-n,
620′, 620′a-n Support segment
621, 621a-n,
621′, 621′a-n Guiding part
622, 622a-n,
622′, 622′a-n Supporting part
623, 623a-d,
623′, 623′a-d Vertical guiding surface
624 Hole
625 Flap
626 Access cabinet
650 Transfer column
660 Storage column
670 Goods holder lift
700 Delivery vehicle
ΔdV, ΔdVa-n Vertical offset
A_{R} Axis of rotation
X First direction
Y Second direction
Z Third direction
PH Horizontal plane

1. A storage module for supporting goods holders in an automated storage and retrieval system, wherein the storage module comprises:
a vertically extending structure, and
a support segment pivotably supported by the vertically extending structure with a vertical axis of rotation,
wherein the support segment comprises:
a supporting part for supporting a goods holder.

2. The storage module according to claim 24, wherein the storage module is configured to form a transfer column by vertically aligning the guiding part of the support segment above a target supporting part.

3. The storage module according to claim 2, wherein the goods holders that the guiding part is intended to guide are rectangular in outline and the guiding part extends at least partly along four sides of such a goods holder to be guided.

4.-5. (canceled)

6. The storage module according to claim 24, wherein the supporting part and the guiding parts are arranged with their geometrical centers at equal distances from the axis of rotation.

7. (canceled)

8. The storage module according to claim 24, wherein the guiding part comprises a plurality of vertical guiding surfaces.

9. The storage module according to claim 24, wherein the storage module comprises a blocker configured to restrict horizontal access between the supporting part and the guiding part.

10. The storage module according to claim 1, wherein the storage module comprises an access cabinet arranged adjacent to the support segment, the access cabinet configured to provide selective access to a goods holder supported by the support segment.

11. The storage module according to claim 1, wherein the support segment comprises one or more flaps arranged on the supporting part, and
wherein the one or more flaps (625) are movable between:
a supporting position in which they are configured to store a goods holder, and
a stowed position in which they are configured to allow vertical passage of a goods holder.

12. The storage module according to claim 26, wherein the guiding part and the supporting part have the same geometry.

13. The storage module according to claim 1, wherein the support segment comprises:
a pair of supporting parts, and
a pair of guiding parts,
wherein the supporting parts and the guiding parts of each support segment are arranged on opposite sides of the axis of rotation.

14. An automated storage and retrieval system for storage and retrieval of goods holders, wherein the automated storage and retrieval system comprises:
a storage module according to claim 1,
a plurality of goods holders stored in the storage module,
a container handling vehicle comprising a lifting device configured to grab and vertically lift a goods holder from a supporting part rotated into alignment with a retrieval/drop-off position for the storage module, and
a control system configured to monitor and control wirelessly movements of the container handling vehicle.

15.-16. (canceled)

17. A method for retrieving a goods holder from an automated storage and retrieval system according to claim 14,
wherein the method comprises:
moving the container handling vehicle to a position where its lifting device is positioned in vertical alignment above a retrieval/drop-off position for the storage module,
rotating a target support segment on which the target goods holder is stored to a first position where the supporting part is vertically aligned with the lifting device of the container handling vehicle,
if the target support segment is not the uppermost support segment, rotating the support segments arranged above the target support segment to a second position where their guiding parts are vertically aligned with the supporting part of the target support segment such that a transfer column is formed above the target goods holder,
grabbing and lifting the target goods holder by use of the lifting device, and
moving the container handling vehicle with the target goods holder to a horizontally different location.

18.-22. (canceled)

23. The storage module according to claim 1, wherein the support segment further comprises a guiding part for guiding vertical movement of a goods holder.

24. The storage module according to claim 23, wherein the supporting part and the guiding part of the support segment are arranged on opposite sides of the axis of rotation.

25. The storage module according to claim 2, wherein the vertically extending structure forms a part of the transfer column.

26. The storage module according to claim 23, wherein the support segment comprises one or more flaps arranged on the guiding part, and
wherein the one or more flaps are movable between:
a supporting position in which they are configured to store a goods holder, and
a stowed position in which they are configured to allow vertical passage of a goods holder.

27. The storage module according to claim 1, wherein the storage module comprises a plurality of the support segments.

28. The storage module according to claim 27, wherein the plurality of support segments are distributed with vertical offsets such that the plurality of support segments are arranged one above another.

29. A method for retrieving a goods holder from an automated storage and retrieval system according to claim 14,
wherein the method comprises:
moving the container handling vehicle to a position where its lifting device is above a retrieval/drop-off position for the storage module;
rotating a target support segment on which a target goods holder is stored to a first position vertically aligned with the lifting device of the container handling vehicle; and
grabbing and lifting the target goods holder using the lifting device.

30. A storage module for supporting goods holders in an automated storage and retrieval system, wherein the storage module comprises:
a vertically extending structure, and
a guiding part for guiding a goods holder, the guiding part being pivotably supported by the vertically extending structure with a vertical axis of rotation.
